(19) United States
(12) Patent Application Publication
(10) Pub. No.: US 2005/0004752 A1
(43) Pub. Date: Jan. 6, 2005

(54) Portable device for indicating specific location and controlling method thereof

(75) Inventors: Sang-on Choi, Suwon-si (KR); Woo-jong Cho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/767,469

(22) Filed: Jan. 30, 2004

(30) Foreign Application Priority Data
Jan. 30, 2003 (KR) 2003-6419

(51) Int. Cl. G01C 21/00

(52) U.S. Cl. 701/207; 701/200

(57) ABSTRACT

Disclosed is a portable device, which has: an input unit inputted with a direction searching command for searching a direction to a specific location and with a current city information setup by a user, a geomagnetic sensor for detecting a geographical direction, a storage unit for storing information on directions between major cities of all the nations and the specific locations, a first display showing the direction to the specific location and an orientation of the portable device on a screen, and a control unit, upon transmission of the direction searching command from the input unit, for indicating the orientation of a portable device and the direction to the specific location on the first display based on the detected geographical direction from the geomagnetic sensor, and the direction information between the current city information setup through the input unit and the specific location stored in the storage unit.

### CROSS-REFERENCE TO RELATED APPLICATIONS

This application claims the benefit of Korean Application No. 2003-6419, filed Jan. 30, 2003, in the Korean Intellectual Property Office, the disclosure of which is incorporated herein by reference.

### BACKGROUND

1. Field of the invention

The present invention relates generally to a portable device having a display, and more particularly, to a portable device for indicating a specific location and a controlling method thereof.

2. Description of the Related Art

1.2 billion Muslims, which comprises about 20% of the global population, are subject to five religious duties including i) Shahada (reciting a creed), ii) Salat (praying 5 times a day), iii) Sakat (salvation), iv) Saum (Lamaism abstinence), and v) Hajj (pilgrimage). Of the five, Salat is considered the most significant by Muslims.

Salat is performed in the morning, at midday, between midday and sunset, at sunset and an hour after sunset by praying toward Mecca after purification, which is performed by removing one's shoes, and washing one's hands and face.

Mecca is a city of Saudi Arabia wherein Ka'ba is located. Ka'ba is a sacred place of Muslims. Wherever Muslims are in the world, they pray toward Ka'ba, the most holy structure in Islam. Ka'ba has a cubical shape, and each side of it correctly matches directions indicated by a compass.

Therefore, Muslims typically carry a compass and a map at all times to indicate the location of Ka'ba.

Meanwhile, portable devices such as mobile phones, personal digital assistance devices (PDAs), laptops, compact disk players (CD players) and MP3 players are now widespread. In particular, portable devices capable of communicating with other devices are continually researched to be used in various fields and not limited only to communication.

Additionally, as infrastructure is built in order that the Internet can be used around the world through portable devices, more and more companies provide Internet services using a geographical information system (GIS) or a global positioning system (GPS). Accordingly, users can enjoy a better quality of life with these diverse services.

However, in spite of development of aforementioned portable devices and such various Internet services, Muslims who are obligated to perform the Salat ritual are still inconvenienced by being required to carry a compass and a map at all times since they must always be mindful of the time of day to perform the ritual, even in the middle of daily work.

Meanwhile, an electronic compass has been introduced. However, this kind of device only indicates the North direction based on the current location; therefore, Muslims must still carry a map to determine the direction of Mecca.

### SUMMARY OF THE INVENTION

The present invention has been developed to solve the above-mentioned problem and accordingly, it is an object of the present invention to provide a portable device directing specific locations that users want to know from anywhere in the world and indicating requested directions precisely, and a controlling method thereof.

According to the present invention there is provided, for achieving the above object, a portable device comprising an input unit to be inputted with a direction searching command for searching directions of the specific location and a current city information setup by a user, a geomagnetic sensor for detecting a geographical direction, a storage unit for storing information on directions between major cities of all the nations and the specific locations, a first display showing the directions of the specific location and an orientation of the portable device on a screen, and a control unit for indicating the orientation of the portable device and the direction to the specific location on the first display based on the detected geographical direction from the geomagnetic sensor, the current city information being setup through the input unit and the direction information stored in the storage unit, upon transmission of the direction searching command from the input unit.

The input unit comprises at least one of a mouse, a touch screen, a key, a keyboard and a microphone.

It is preferable that the portable device further comprises a second display, which is controlled by the control unit, for generating an alarm when the orientation of the device and the direction to the specific location are aligned with each other. Here, the second display comprises at least one of a light emitting diode (LED), a speaker and the first display.

The portable device further comprises a data transceiver for communicating with a setup time informing server connected by a network, wherein the control unit generates an alarm through the second display, upon being informed of a setup time from the setup time informing server through the transceiver, and automatically indicates the direction to the specific location and the orientation of the portable device according to the geographical direction.

The control unit displays a screen for setting up the current city information on the first display when a mode for searching for the direction to the specific location is selected through the input unit. Further, the control unit indicates the direction to the specific location and an orientation of the portable device according to the geographical direction when current city information setup is completed. Alternatively, the control unit stores the setup information after completing the current city information setup, and then indicates the direction to the specific location and the orientation of the portable device through a direction searching process when a user selects the direction searching command from the menu for which is provided as the user selects a direction searching mode for the specific location.

On the other hand, the control unit provides the current city information setup screen with a continent select menu and a major city menu as a submenu to the continent select menu, the major city menu for selecting major cities belonging to the selected continent. The control unit further provides confirmation buttons to complete setup of the current city information to the current city information setup screen.

To achieve the above object, a method for controlling the portable device according to the present invention comprises the steps of setting up a direction information between major cities of all the nations and specific locations, setting up current city information on a city selected by a user, detecting a geographical direction, and displaying the direction of the device and the direction to the specific locations on a screen of a first display based on the detected geographical direction and a direction information between the set up current city information and the specific locations, upon transmission of the direction searching command.

The direction searching command and the current city information setup are inputted according to an input signal from at least one of a mouse, a touch screen, a key, a keyboard and a microphone.

Additionally, a method for controlling the portable device further comprises the step of generating an alarm when an orientation of the device and the direction to the specific location correspond.

Moreover, a method for controlling the potable device further comprises the steps of communicating with a setup time informing server connected by a network, and generating an alarm, upon being informed of setup time from the setup time informing server and then automatically indicating a direction to the specific location and an orientation of the portable device according to the detected geographical direction.

The step of setting up current city information comprises the step of providing a screen for setting up the current city information when a mode for searching for a direction to the specific location is selected. Further, a screen providing step for setup of the current city information comprises the steps of providing a continent select menu to the current city information setup screen; and providing a major city menu to the current city information setup screen as a submenu to the continent select menu, the major city menu for selecting major cities belonging to the selected continent.

A portable device to achieve the above object according to the present invention comprises an input unit to be inputted with a mode and a direction searching command for searching directions of the specific location by a user, a geomagnetic sensor for detecting geographical direction, a data transceiver for communicating with a location information providing server connected by a network, a storage unit for storing information on directions between major cities of all the nations and the specific locations, a first display showing the direction to the specific location and an orientation of the portable device on a screen, and a control unit for indicating the orientation of the portable device and the direction to the specific location on the display based on the detected geographical direction from the geomagnetic sensor, and the direction information between the current city information supplied from the location information providing server through the transceiver and the specific location stored in the storage unit.

The control unit generates an alarm upon being informed of setup time from the setup time informing server through the transceiver, and automatically indicates the direction to the specific location and the orientation of the portable device according to the geographical direction.

According to the present invention, there is provided, for achieving the above object, a portable device that sets up a direction information between major cities of all the nations and the specific locations, sets up a current city information by communicating with a location information providing server connected by network, detects the geographical direction, and displays the orientation of the portable device and the direction to the specific location on a screen of a first display based on the detected geographical direction, and the direction information between the current city information and the specific location received from the transceiver, upon transmission of the direction searching command.

Moreover, a method for controlling the potable device further comprises the steps of communicating with a setup time informing server connected by a network, and generating an alarm, upon being informed of setup time from the setup time informing server and then automatically indicating a direction to the specific location and an orientation of the portable device according to the detected geographical direction.

The portable device stated above, according to the present invention, indicates an orientation of the device and the direction to the specific location at any time desired by the user or at a predefined setup time, and enables the user to be aware of a precise direction by providing an alarm according to correspondence of the two directions.

### BRIEF DESCRIPTION OF THE DRAWINGS

These and other features, aspects, and advantages of the present invention will become better understood with regard to the following description, appended claims, and accompanying drawings in which:

FIG. 1 is a block diagram of a portable device in accordance with a preferred embodiment of the present invention;

FIG. 2 is a flowchart illustrating an example of operation of the portable device of FIG. 1;

FIG. 3 is a flowchart illustrating another example of operation of the portable device of FIG. 1;

FIG. 4 is a flowchart illustrating yet another example of operation of the portable device of FIG. 1;

FIG. 5 illustrates an example of current city information setup screen of FIG. 2;

FIG. 6 illustrates an example of indicating a direction of specific locations and an orientation of the system through the processes in FIG. 3 or FIG. 4; and

FIG. 7 illustrates an example of indicating a case in which a direction to the specific location and an orientation of the system correspond, as rotating the system.

### DETAILED DESCRIPTION OF THE PREFERRED EMBODIMENTS

A portable device according to the embodiment of the present invention will now be described in detail with reference to the accompanying drawings.

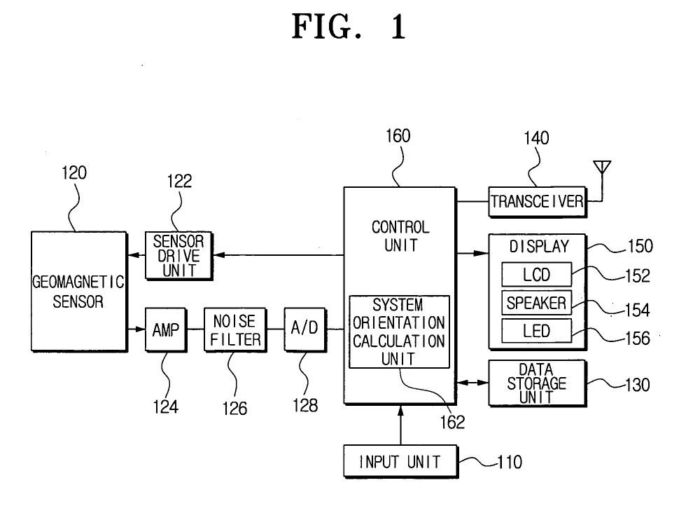

FIG. 1 is a block diagram of the portable device in accordance with one preferred embodiment of the present invention. The device comprises an input unit 110, a geomagnetic sensor 120, a data storage unit 130, a data transceiver 140, a display 150 and a control unit 160. Additionally, the device further comprises a sensor drive unit 122, an amplifier 124, a noise filter 126 and an analogue-to-digital (A/D) converter 128.

The input unit 110 is inputted with a command and optional items selected by a user through an inputting tool. The inputting tool can be at least one of a mouse, a touch screen, a key, a keyboard and a microphone. The microphone enables the user to set up city information of the city where the user is located by an audio signal.

The geomagnetic sensor 120 detects geomagnetic field under the control of the control unit 160. The geomagnetic sensor 120 is driven by the sensor drive unit 122, and the amplifier 124 and the noise filter 126 are used as a noise remover for the detected signal. Further, the analogue-to-digital converter 128 converts analogue signals output through the noise filter 126 into the digital signals.

The data storage unit 130 stores information on a direction between major cities of all the nations and the specific locations, such as Mecca.

The data transceiver 140 interchanges data with a base station (not shown) or a low earth orbit-satellite under the control of the control unit 160.

The display 150 comprises a liquid crystal display (LCD) 152, a speaker 154 and a light emitting diode (LED) 156. The LCD 152 displays setting up city information of the city where the user is located under the control of the control unit 160, and further displays a screen for indicating a direction of specific location and an orientation of the system. The speaker 154 generates an alarm when a direction to the specific location and an orientation of the system correspond, for example, by an audio signal. The LED 156 also has a function of notifying when a direction to the specific location and an orientation of the system correspond, by generating a visual alarm to the user. Additionally, the LCD is also able to generate an alarm by flickering or displaying a pop-up sign under the control of the control unit 160. In addition, the display 150 can be a touch screen, by way of an example, which has functions of both input and output. Further, other tools, in addition to an LCD, can be adopted to perform a screen display.

The control unit 160 comprises a system orientation calculating unit 162 for calculating an orientation of the system based on the geographical directions detected by the geomagnetic sensor 120, and controls overall functions of the system such as sensing an input, driving the geomagnetic sensor 120 and reading data from the data storage unit 130.

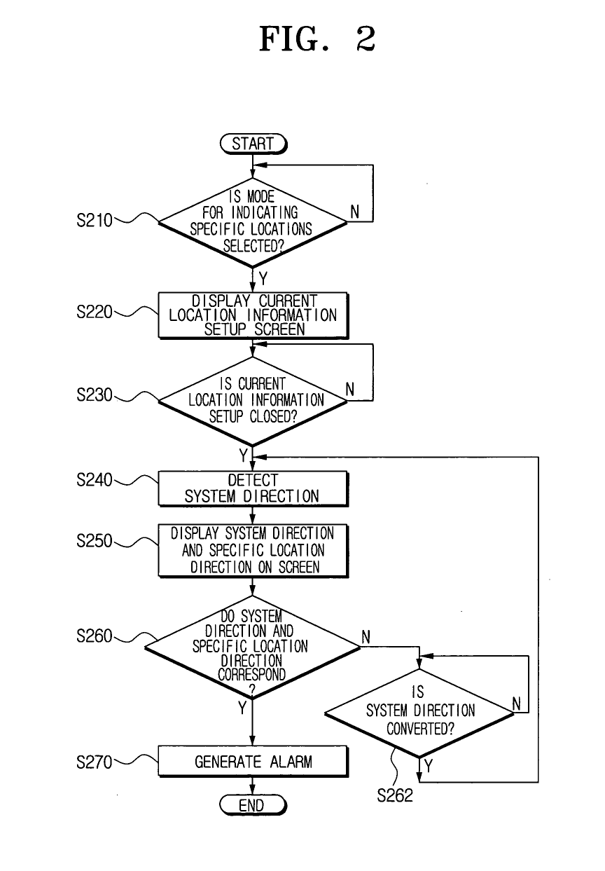

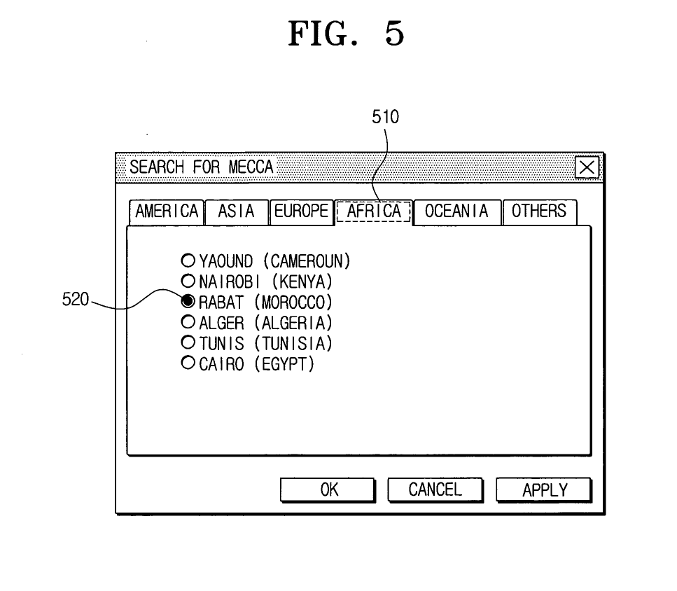

FIG. 2 is a flowchart illustrating an example of operation of the portable device shown in FIG. 1. The user selects a mode for indicating a direction of specific locations through an input unit 110 (S210), and then the control unit 160 displays a current city selection menu on the LCD 152 (S220). Here, as shown in FIG. 5, the current city selection menu provides a continent select menu, and a main city menu as a submenu of a selected continent 510 in the continent select menu. The current city selection menu may further provide confirmation buttons such as an “O.K.” button, a “cancel” button and an “apply” button so that the user can complete the selection, as shown in FIG. 5.

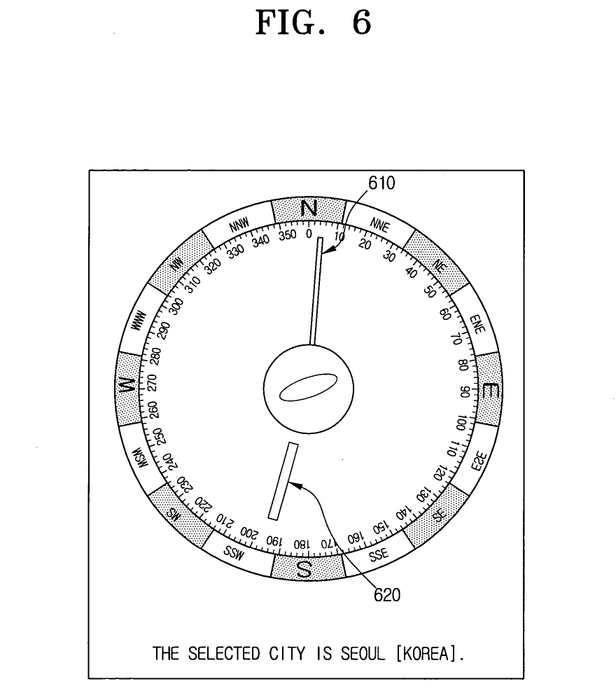

Additionally, when the setup is completed (S230), the control unit 160 detects the geographical direction by driving the geomagnetic sensor 120 with the sensor drive unit 122, and thereby detects the orientation of the system (S240). Further, the control unit 160 reads direction information stored in the data storage unit 130 about the direction information between the current city and a specific location, such as Mecca, and displays orientation of the system and the direction to the specific location according to the geographical direction information on a screen, as shown in FIG. 6, through indicators 610, 620 (S250).

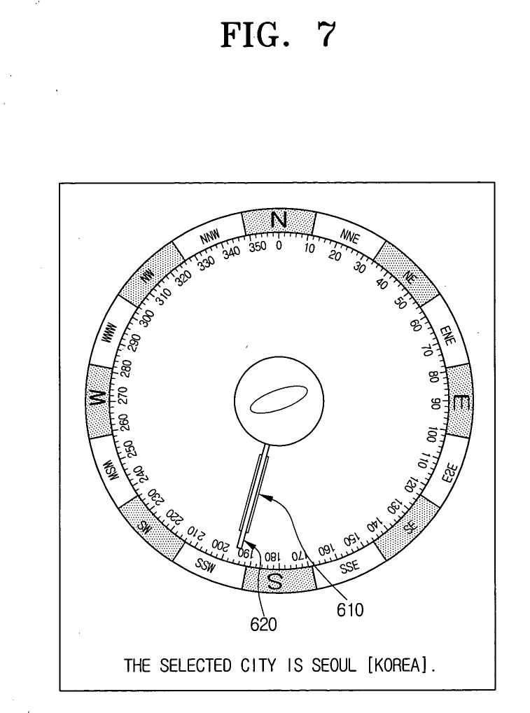

FIG. 6 further indicates a message regarding a currently selected city. If the user changes the orientation of the system (S262), the control unit 160 accordingly displays the detection results of the varying orientation of the system, and generates an alarm (S270) when the system head on a screen is in a direction to a specific location (S260). Here, various methods such as flickering of an LCD 156 or sound through a speaker 154 can be adopted for the alarm. Additionally, flickering of a direction indicator indicating specific directions on an LCD 156 or pop-up windows can serve as an alarm. FIG. 7 shows a case wherein two indicators, one for a system head direction and the other for a specific location, are aligned with each other in the same direction.

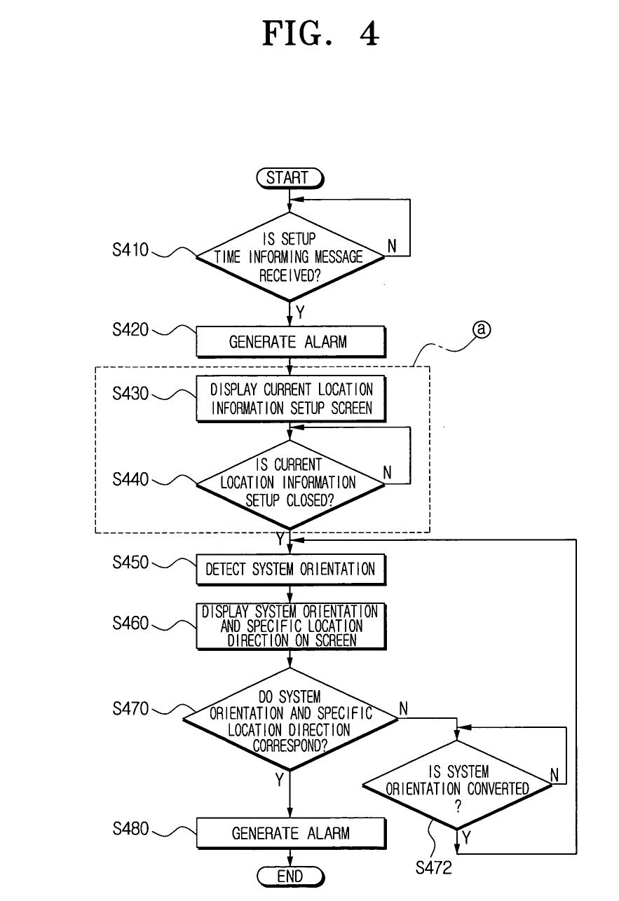

On the other hand, before performing the processes of FIG. 2, a portable device according to the present invention is able to generate an alarm upon receiving a setup time informing message from a setup time informing server (not shown) connected to the Internet and indicate a current city information setup screen (FIG. 5) automatically. FIG. 4 is a flowchart illustrating operations when a portable device of FIG. 1 has received a setup time informing message form a setup time informing server through a neighboring base station. Compared to FIG. 2, a process of alarming (S420) according to the result of receiving a setup time informing message (S410) is further included in FIG. 4.

Alternatively, a portable device according to the present invention may be designed only to generate an alarm upon receiving a setup time informing message from the setup time informing server connected to the Internet, before performing the processes of FIG. 2. In other words, the device can display a setup screen when the user selects a direction indicating mode for indicating a specific location.

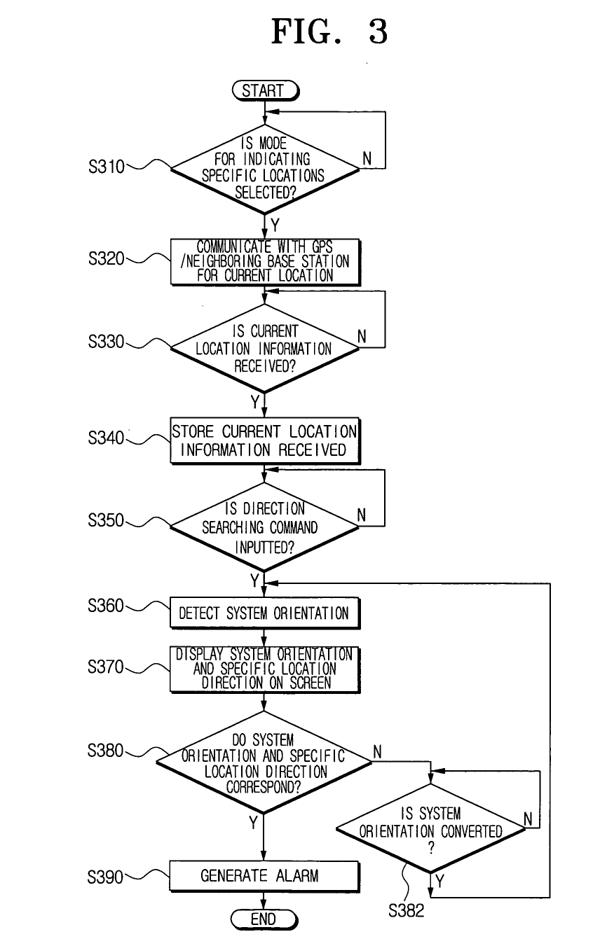

FIG. 3 is a flowchart of another operation method of a portable device of FIG. 1. A mode for indicating a specific location is selected through an input unit 110 (S310). Or, the control unit 160 may automatically communicate with low earth orbit-satellites for GPS or neighboring base stations by a transceiver 140 to inquire about current location information of the system through the location information providing server connected to the Internet (S320). In case of the latter, the process S310 is omitted. Afterward, upon receiving current location information from the location information providing server (S330), the control unit 160 stores the received information (S340). Upon receiving a direction searching command through the input unit 110 (S350), the control unit 160, while detecting the geographical direction by driving the geomagnetic sensor 120 with the sensor drive unit 122, reads direction information stored in the data storage unit 130, between a specific location, such as Mecca, and city information acquired by current location information received from the location information providing server (S360), and displays on a screen a system head direction indicator (610) and a specific location direction indicator (620) according to the detected geographical direction information, as shown in FIG. 6 (S370).

In FIG. 6, further indicated is a message regarding a currently selected city in the bottom. Here, as the user varies the position of the system (S382), the control unit 160 accordingly displays the detection results of the varying orientation of the system head, and generates an alarm (S390) upon a correspondence between the system head direction indicator 610 and the specific location direction indicator 620 (S280) on a screen. FIG. 7 shows a case wherein two indicators, the system head direction indicator 610 for a system head direction and the specific location direction indicator 620 for a specific location direction, are aligned with each other in the same direction.

Meanwhile, before the process of FIG. 3, the control unit 160 performs the processes of FIG. 4 except the process indicated by the symbol \mathring{a}. That is, upon receiving a setup time informing message from a setup time informing server connected to the Internet (S410), as shown in FIG. 4, the control unit 160 generates an alarm (S420) and automatically displays an orientation of the system and direction to a specific location through a process of S450 (S460). FIG. 4 further comprises a process of generating an alarm (S420) according to the received result of a setup time informing message (S410), but omits the process \mathring{a}, that is inputting a direction searching command from the user. The rest of operations are the same as the operations in FIG. 3.

The operations in FIG. 2, applied to the portable device by way of example, are also applicable to the devices for indicating specific locations to the user without particular communicating function. The operation in FIG. 3 can be adopted into a device having a communication function. As a result, a device having a communication function enables itself to provide more various services.

The above portable device and a controlling method thereof can perform functions of generating an alarm at a setup time and precisely indicating a direction to specific locations, such that it can solve existing problems such as anxiety about time, inconvenience of having to use and carry a map and/or a compass.

Specifically, with the above portable device, it is possible to remind Muslims of the five prayer times precisely as well as provide the appropriate direction they should face. Accordingly, they can easily perform the ritual toward the correct direction to Mecca.

While the invention has been shown and described with reference to certain preferred embodiments thereof, it will be understood by those skilled in the art that various changes in form and details may be made therein without departing from the spirit and scope of the invention as defined by the appended claims.

1. A portable device for indicating a direction to a specific location comprising:
an input unit inputted with a direction searching command for searching a direction to the specific location and with a current city information setup by a user;
a geomagnetic sensor for detecting a geographical direction;
a storage unit for storing information on directions between major cities of all the nations and the specific locations;
a first display showing the direction to the specific location and an orientation of the portable device on a screen; and
a control unit, upon transmission of the direction searching command from the input unit, for indicating the orientation of a portable device and the direction to the specific location on the first display based on the detected geographical direction from the geomagnetic sensor, and the direction information between the current city information setup through the input unit and the specific location stored in the storage unit.

2. The portable device of claim 1, wherein the input unit comprises at least one of a mouse, a touch screen, a key, a keyboard and a microphone.

3. The portable device of claim 1, further comprising a second display, which is controlled by the control unit, for generating an alarm when the orientation of the device and the direction to the specific location are aligned with each other.

4. The portable device of claim 3, wherein the second display comprises at least one of a light emitting diode, a speaker and the first display.

5. The portable device of claim 4, further comprising a data transceiver for communicating with a setup time informing server connected by a network, wherein the control unit generates an alarm through the second display, upon being informed of setup time from the setup time informing server through the transceiver, and automatically indicates the direction to the specific location and the orientation of the portable device according to the geographical direction.

6. The portable device of claim 1, wherein the control unit displays a screen for setting up the current city information on the first display when a mode for searching for the direction to the specific location is selected through the input unit.

7. The portable device of claim 6, wherein the control unit provides the current city information setup screen with a continent select menu and a major city menu for selecting major cities belonging to the selected continent, as a submenu to the continent select menu.

8. The portable device of claim 6, wherein the control unit further provides confirmation buttons to the current city information setup screen to complete setup of the current city information.

9. A method for controlling a portable device for indicating a direction to a specific location comprising the steps of:
setting up a direction information about directions between major cities of all the nations and a specific location;
setting up a current city information about a city selected by a user;
detecting a geographical direction; and
displaying the orientation of the device and the direction to the specific locations on a screen of a first display based on the detected geographical direction, and the direction information between the set up current city information and the specific location, when the direction searching command is transmitted.

10. The controlling method of claim 9, wherein the direction searching command and the current city information setup are inputted according to an input signal from at least one of a mouse, a touch screen, a key, a keyboard and a microphone.

11. The controlling method of claim 9, further comprising the step of generating an alarm when the orientation of the device and the direction to the specific location correspond.

12. The controlling method of claim 11, wherein the alarm is generated through at least one of a light emitting diode, a speaker and the first display.

13. The controlling method of claim 12, further comprising the steps of:
communicating with a setup time informing server connected by a network; and
when the setup time is informed from the setup time informing server, generating an alarm, and automatically indicating a direction to the specific location and an orientation of the portable device according to the detected geographical direction.

14. The controlling method of claim 9, wherein a current city information setup step displays a screen for setting up the current city information when a mode for searching for a direction to the specific location is selected.

15. The controlling method of claim 14, wherein a screen providing step for setup of the current city information comprises the steps of:
providing a continent select menu to the current city information setup screen; and
providing a major city menu, to the current city information setup screen, as a submenu to the continent select menu, the major city menu for selecting major cities belonging to the selected continent.

16. A portable device comprising:
an input unit inputted with a mode and a direction searching command for searching a direction to a specific location by a user;
a geomagnetic sensor for detecting a geographical direction;
a data transceiver for communicating with a location information providing server connected to the Internet;
a storage unit for storing information on directions between major cities of all the nations and the specific locations;
a first display showing the direction to the specific location and an orientation of the portable device on a screen; and
a control unit, when the direction searching command is transmitted from the input unit, for indicating the orientation of the portable device and the direction to the specific location on the display based on the detected geographical direction from the geomagnetic sensor, and the direction information between the current city information supplied from the location information providing server through the transceiver and the specific location stored in the storage unit.

17. A portable device of claim 16, wherein the input unit comprises at least one of a mouse, a touch screen, a key, a keyboard and a microphone.

18. A portable device of claim 16, further comprising a second display, which is controlled by the control unit, for generating an alarm when the orientation of the device and the direction to the specific location are aligned with each other.

19. A portable device of claim 18, wherein the second display comprises at least one of a light emitting diode, a speaker and the first display.

20. A portable device of claim 19, wherein when a setup time is informed from a setup time informing server connected to the Internet through the transceiver, the control unit generates an alarm through the second display, and automatically indicates the direction to the specific location and an orientation of the portable device according to the detected geographical direction.

21. A method for controlling a portable device for indicating a direction to specific locations comprising steps of:
setting up a direction information about directions between major cities of all the nations and a specific location;
setting up a current city information by communicating with a location information providing server connected by a network;
detecting the geographical direction; and
when the direction searching command is transmitted, displaying the orientation of the device and the direction to the specific locations on a screen of a first display based on the detected geographical direction, and the direction information between the current city information received from the location information providing server and the specific location.

22. The control method of claim 21, wherein the direction searching command and the current city information setup are determined according to an input signal from at least one of a mouse, a touch screen, a key, a keyboard and a microphone.

23. The control method of claim 21, further comprising the step of generating an alarm when the orientation of the device and the direction to the specific location correspond.

24. The control method of claim 23, wherein the alarm is generated through at least one of a light emitting diode, a speaker and the first display.

25. The control method of claim 24, further comprising the steps of:
communicating with a setup time informing server connected by a network; and
generating an alarm, upon being informed of setup time from the setup time informing server and then automatically indicating a direction to the specific location and an orientation of the portable device according to the detected geographical direction.
